(19) United States
(12) Patent Application Publication
(10) Pub. No.: US 2026/0031520 A1
(43) Pub. Date: Jan. 29, 2026

(54) ADJUSTABLE ANTENNA MOUNTING FOR MONOPOLE TOWER

(71) Applicant: Sabre Communications Corporation, Sioux City, IA (US)

(72) Inventors: Carlo Umberto Franceschino, London (CA); Michael James Burnett, Sioux city, IA (US)

(21) Appl. No.: 18/786,150

(22) Filed: Jul. 26, 2024

(51) Int. Cl. H01Q 1/12; H01Q 1/24; H01Q 3/02; H01Q 9/30

(52) U.S. Cl. CPC H01Q 1/1228; H01Q 1/246; H01Q 3/02; H01Q 9/30

(57) ABSTRACT

A mounting system for communication equipment on monopole towers can include a first mounting assembly with upper and lower pole attachment mounts connected by multiple arms to face members. The system can include a plurality of antenna offset mounts, each featuring a coupler for removable attachment to the face members. The offset mounts can be end-user-adjustable, e.g., allowing precise positioning of antennas at specified offset distances from the face members. In an example, the antenna offset mounts can facilitate antenna placement at various angles and distances from the face plane of the mounting assembly, such as to provide versatile antenna placement options for optimizing signal coverage and performance in communication networks.

### TECHNICAL FIELD

This document pertains generally, but not by way of limitation, to communications equipment mounting devices such as for utility poles such as monopoles, such as for raised antenna implementations in the field.

### BACKGROUND

Utility and communication poles can include monopoles that can be used to raise or support lights, antennas or other communications equipment, or other devices above the surface to which they are mounted. Fixtures can be mounted to the monopole, such as at an extended distance above the earth or other surface from which the monopole extends. A human worker may climb the monopole and work on the fixture. Equipment may be mounted to the monopole, such as by the worker standing on the fixture.

### BRIEF DESCRIPTION OF THE DRAWINGS

FIG. 1A is a perspective view of an example of an antenna offset mount.

FIG. 1B is a top view of an example of an antenna offset mount.

FIG. 1C is a side view of an example of an antenna offset mount.

FIG. 2A is a top view of a plurality of antenna offset mounts attached to a mounting assembly.

FIG. 2B is a top view of a plurality of antenna offset mounts attached to a mounting assembly, oriented such that individual antennas face a plane having an angle from a corresponding face member.

FIG. 3 is a perspective view of a plurality of antenna offset mounts attached to a mounting assembly.

FIG. 4A depicts a top view of an example of the mounting assembly.

FIG. 4B depicts a side view of an example of the mounting assembly.

FIG. 4C depicts an isometric view of an example of a mounting assembly.

FIG. 5 depicts a mounting system including multiple mounting assemblies attached adjacent to one another around a monopole.

FIG. 6 illustrates a flowchart of a method for mounting communication equipment to a monopole tower.

### DETAILED DESCRIPTION

Monopole towers are structures for supporting various types of communication equipment, including antennas and other signal transmission devices. For example, the tower can support equipment (e.g., power wires, telecommunication equipment or wires, or the like). In an example, a series of towers are arranged alongside a roadway and power transmission lines are strung along the series of utility poles. In another example, cellular device infrastructure (e.g., antennas, data processing equipment, or the like) can be coupled to the tower. The tower extends a distance from the mounting structure to a base to elevate the equipment so that the equipment is isolated from the ground surface, for example to provide a clear electromagnetic access path to a raised antenna or to allow vehicles or people to travel beneath the equipment without coming into contact with the equipment.

Mounting systems for monopole towers must accommodate different types of antennas and equipment while providing structural integrity and ease of installation. As communication technologies advance, it is desirable for a versatile and adaptable monopole mounting solution that for supporting a range of antenna configurations and equipment types. The present inventors have recognized the benefits of systems and methods for mounting equipment to a monopole while providing an ability to adjust antenna positions and orientations, such as to help promote signal coverage and minimizing interference in certain network environments.

In one approach, a round or circular mounting assembly can be fixed or clamped to the tower. The round mounting assembly can permit communications equipment to be positioned at various azimuths located 360° around the monopole, and selective positioning antennas at the various azimuths can help optimize equipment function. Also, communications equipment can be occasionally re-configured or adjusted, e.g., radially around the round mounting assembly, while the assembly remains fixed to the monopole (i.e., without rotating the entire assembly). A challenge of round or circular mounting assemblies, however, is that they must either be 1) assembled on the ground and raised to the top position only of a pole 2) assembled in the air, e.g., where it can be arduous to fit pieces together.

In another approach, a plurality of mounting assemblies can be adjacently installed at various azimuths around the monopole to form a polygon. Here, each of the plurality of mounting assemblies can each define a sector of a collective multi-sector mounting system. An advantage of a multi-sector mounting system is that each sector can be assembled, equipment attached thereto on the ground, and the sectors can be individually raised and mounted around the monopole. Such individual raising and mounting of a sector permits more flexibility to raise the individual past an obstacle. Also, such a multi-sector mounting system, e.g., having three sectors forming a peripheral triangle, can be significantly easier to assemble and install than a round mounting assembly. A challenge of some multi-sector mounting systems, however, is that they can accommodate fewer equipment configurations than a round mounting assembly. Further, increasing the number of azimuths available for positioning antennas or other communication equipment with certain multi-sector mounting systems can involve adding more sectors.

This document, among other things, describes a mounting system for attaching communication equipment, specifically antennas, to monopole towers. The system can include a mounting assembly that attaches to the tower (e.g., a monopole). The mounting assembly can include upper and lower parts connecting to the tower such as via arms extending outward from the tower. The mounting assembly can provide face members at various azimuths from the monopole, and antennas can ultimately be mounted to an individual face member. For example, the system can include one or more adjustable antenna mounts that can be attached to or removed (e.g., via an end-user) from the face members. In an example, an end-user (e.g., a tower technician, a tower equipment installer, a tower climber, etc.) can adjust these mounts such as to position antennas at different distances from their respective face members, and this adjustment can be made on-site without requiring dismantling of the mounting assembly from the tower. The system can allow that multiple antennas be mounted, each potentially at a different distance or angle with respect to a corresponding face member, which can promote signal coverage. Such a technique can provides a flexible, user-friendly way to mount and adjust multiple antennas on a monopole tower.

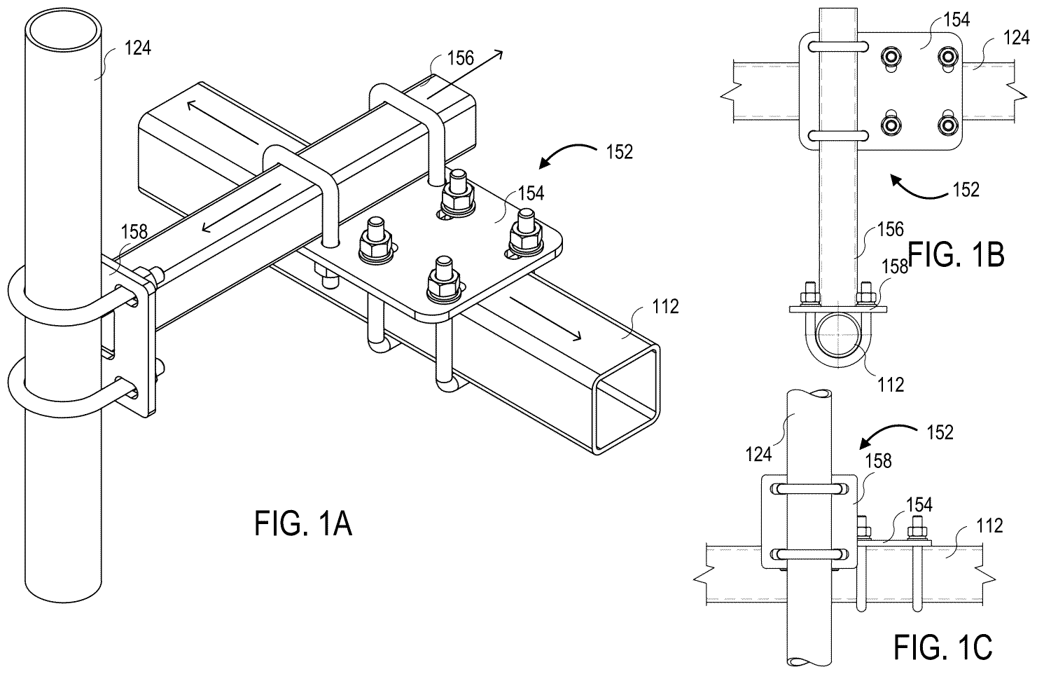

FIG. 1A, FIG. 1B, and FIG. 1C each show respective views of an example of an antenna offset mount. An antenna offset mount 152 can include a coupler 154 for removably coupling with a mounting assembly, such as included in a multi-sector system. For example, the coupler 154 can be sized and shaped for removable coupling with a face member 112 of the mounting assembly, such as a horizontally arranged bar.

In an example, the coupler 154 can include one or more U-bolts (e.g., round or square) sized and shaped to substantially conform to a contour of the face member 112. Other attachment mechanisms, such as 3-bolt clamps, wedge clamps, compression rings, set screws, plate clamps, etc. can be included in the coupler 154 to couple with a face member 112. In an example, the coupler 154 can provide an intermediate coupling action where the antenna offset mount 152 is substantially secured to the face member 112 yet allowed to travel laterally along the face member 112 before being eventually tightened or otherwise secured. Such an intermediate coupling action can facilitate end-user placement of the antenna offset mount 152 (and therefore, an antenna attached thereto) to laterally position the mount 152 relative to the mounting assembly.

In an example, the antenna offset mount 152 can include an elongate member 156. The elongate member 156 can travel, e.g., in a direction substantially perpendicular to the face member 112, along the antenna offset mount 152 such as to modify an offset distance of an antenna (e.g., attached at a distal end 158 of the elongate member 156) from the face member 112. For example, the elongate member 156 can travel through a passage (e.g., between one or more U-bolts and a surface of the coupler 154). Similar to that described above with the lateral positioning of the mount 152, the elongate member can be allowed to travel in the substantially perpendicular direction (e.g., toward or away from the face member 112) before being eventually tightened or otherwise secured.

In an example, at or near the distal end 158 of the elongate member 156, the antenna offset mount 152 can include an attachment for a vertical antenna mounting pipe 124. For example, the distal end 158 of the elongate member 156 can include a flare or a base, e.g., including holes to accept one or more U-bolts, clasps, clamps, etc., therethrough. A vertical antenna mounting pipe 124 can be attached to, sealed to, locked to, coupled to, or otherwise affixed to, the distal end 158. Such a pipe 124 can be sized and shaped to receive a particular electronic device including, for example, an antenna, an amplifying device, or an emitting device.

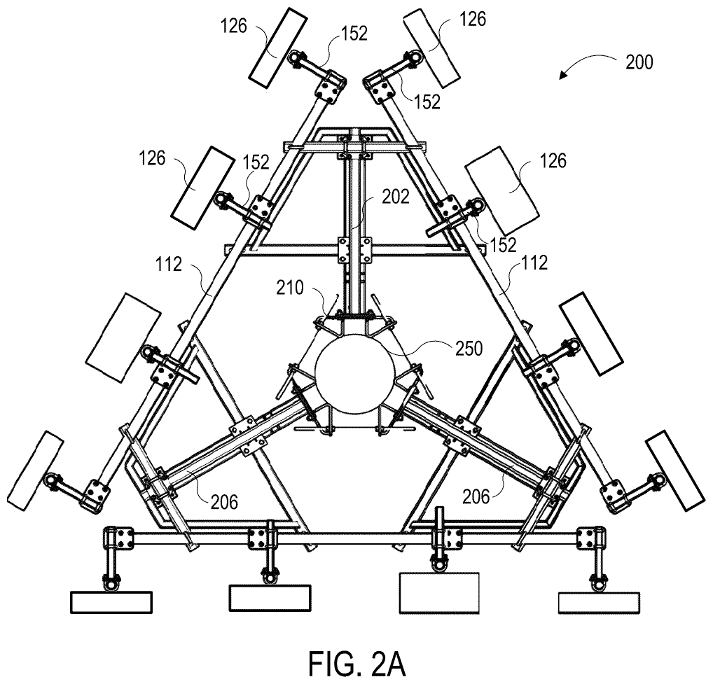

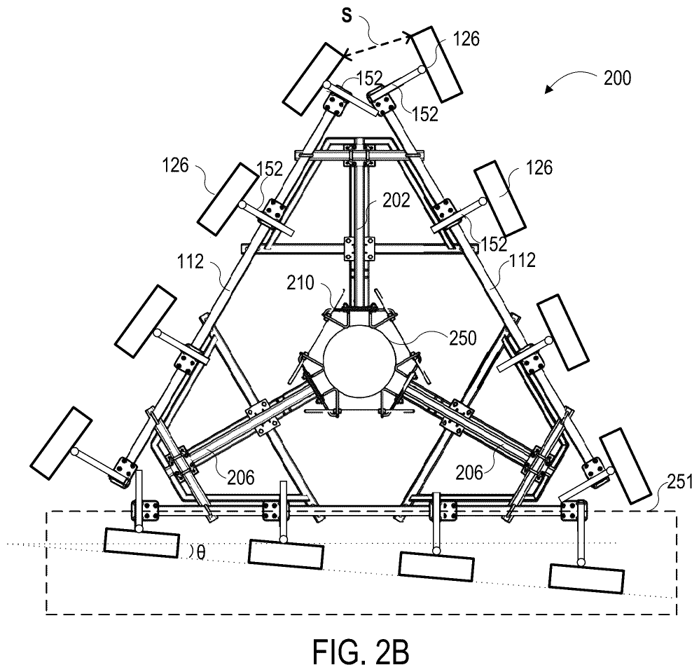

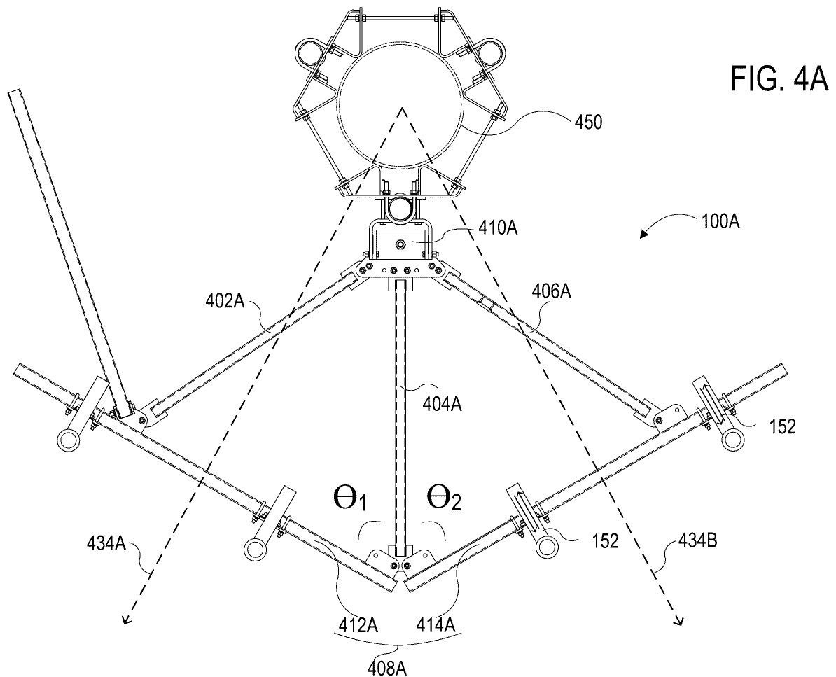

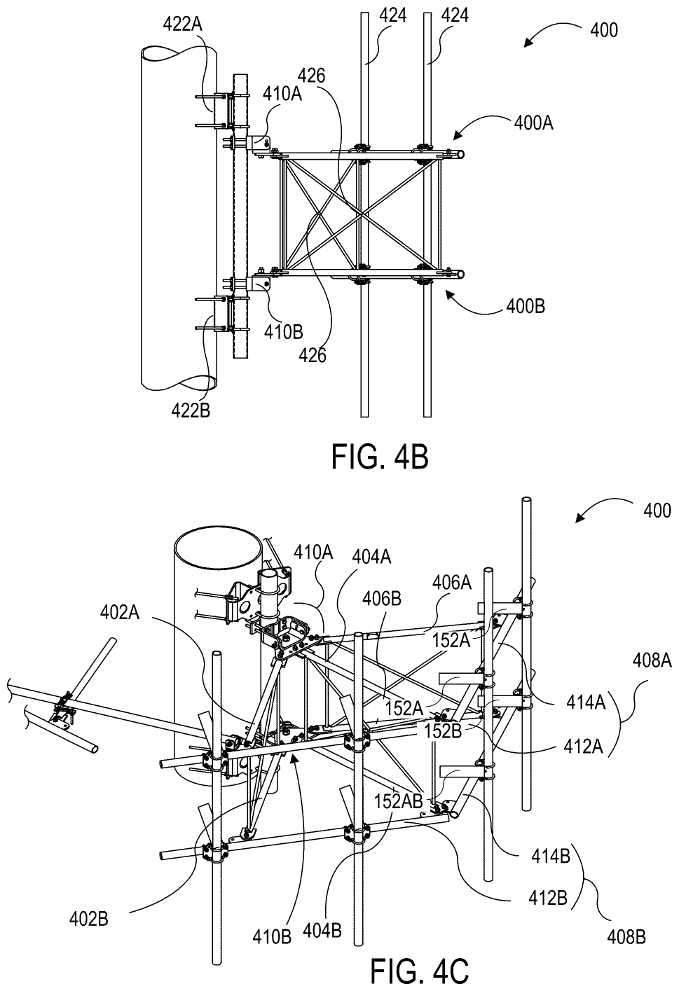

FIG. 2A is a top view of a plurality of antenna offset mounts attached to a mounting assembly. In an example, a multi-sector system 200 can include or use an attachment mount 210, one or more first arms 202, one or more second arms 206, one or more face members 112, and a plurality of antenna offset mounts 152. Similar to that explained below with respect to FIG. 4A, FIG. 4B, and FIG. 4C, a multi-sector system 200 can include a plurality of assemblies which can be, e.g., modularly arrange around a monopole 250 such as to provide face members 112 directed toward a plurality of different azimuths. As depicted in FIG. 2, the combined assemblies of the multi-sector system 200 can form a substantially isosceles triangle around the monopole 250.

In an example, the plurality of antenna offset mounts 152 can be mounted along one or more face members 112 of the multi-sector system 200. An individual mount 152 of the plurality of antenna offset mounts can be adjusted via an end user such as to position an antenna 126 attached thereto according to a respective, specified offset distance. In an example, the specified offset distance can be within a range of about 0.5 inches to about 24 inches (e.g., suitable for receiving an E911 or a Broadband Personal Communications Service (PCS) antenna). In an example, multiple antennas 126 can be mounted at incrementally different offset distances, with respect to one another, along an individual face member 112. The different offset distances can permit respective antennas to remain at different offset distances from the monopole 250 such as to help promote increased signal coverage. For example, first and second offset distances of two different antennas (e.g., mounted to respective different antenna offset mounts 152) can differ by at least 2 inches (in), at least 3 in, at least 6 in, or at least 12 in. In an example, an individual distance ‘offset’ can be calculated including input from a service provider (e.g., a cellular provider) such as depending on the types and configurations of other equipment being employed and desired signal transmission properties while being mounted on the monopole 250. For example, a field associated with an individual antenna 126 can be measured, and a corresponding offset distance can be determined at least in part based on the measured field. In an example, multiple antennas 126 can be sized and shaped different than one another. Here, the multiple antennas 126 can be mounted at incrementally different offset distances, with respect to one another, along an individual face member 112, such as to arrange the antennas 126 at a substantially same offset distance from the corresponding face member as one another. Such different offset distances, each according to a size and shape of a respective antenna, can help mitigate size differences between the antennas 126.

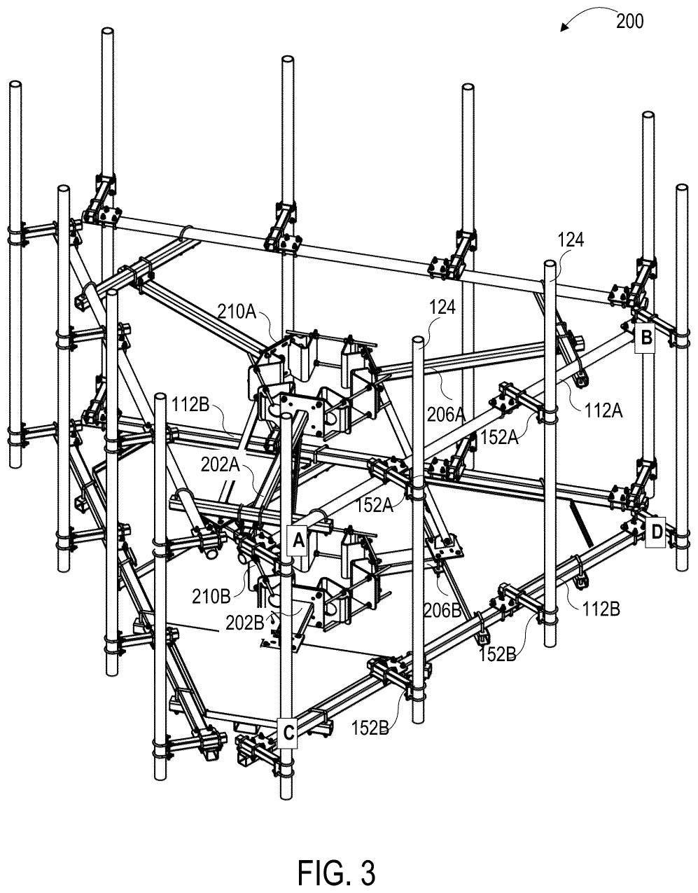

FIG. 2B is a top view of a plurality of antenna offset mounts attached to a mounting assembly, oriented such that individual antennas face a plane having an angle from a corresponding face member. In an example, the multi-sector system 200 of FIG. 2A can be arranged such that individual antennas 126 face in a non-perpendicular direction from a corresponding face member 112. Here, individual antennas 126 can be positioned at an angle (e.g., via rotation at the attachment between the antenna 126 and a corresponding vertical antenna mounting pipe 124) and concurrently positioned at a specified offset distance (e.g., via adjusting the corresponding antenna offset mount 152) such that each antenna along the face member 112 substantially conforms to a common plane. For example, a portion 251 can include an arrangement of a plurality of individual antennas 126, each rotationally arranged on respective vertical antenna mounting pipes 124 and each at different specified offset distances than one another from the face member 112, such as to orient an outer face of each antenna 126 to conform to the same plane. In an example, the plane can be at an angle θ from the face member 112. For example, the angle θ can be greater than about 2°, about 5°, about 7°, about 10°, about 15°, or about 20°. Based on the value of the angle θ, first and second face members 112 can have adjacent antennas 126 arranged at a minimum spacing “s”. For example, the minimum spacing S can increase as the angle θ of the first, second, or both first and second face members 112 is increased. In an example, first, second, and third face members 112 can each include respective antennas 126 arranged at respective, substantially similar angles θ from their respective face members 112. Here, the first, second, and third face members 112 can each include respective antennas 126 arranged to conform to respective first, second, and third planes. In an example and as depicted in FIG. 2B, the first, second, and third planes can form a substantially isosceles triangle. For example, the substantially isosceles triangle formed by the first, second, and third planes can be rotationally offset, with respect to a midpoint defined by a center of the monopole 250, from a substantially isosceles triangle formed by the first, second, and third face members 112. FIG. 3 is a perspective view of a plurality of antenna offset mounts attached to a mounting assembly. In an example, the multi-sector system 200 can include or use an upper attachment mounts 210A, a lower attachment mount 210B, one or more first upper arms 202A, one or more first lower arms 202B, one or more second upper arms 206A, one or more second lower arms 206B, one or more upper face members 112A, one or more lower face members 112B, a plurality of upper antenna offset mounts 152A, and a plurality of lower antenna offset mounts 152B. While these components labeled “upper” are intended to be used in a structurally stable mounting structure sector together with similar components labeled “lower.” this is preferred but not required. As such, a multi-sector system 200 can include parts of the “upper” section without needing to include any corresponding parts of a lower section, or vice-versa.

In an example, an individual sector of the multi-sector system 200 can include first and second upper arms 202A & 206A, include proximal ends that are couplable to the upper pole attachment mount 210A. Similarly, the individual sector can include first and second lower arms 202B & 206B with proximal ends couplable to the lower pole attachment mount 210A. The first and second upper arms 202A & 206A can be attached to an upper face member 112A, and the first and second lower arms 202B & 206B can be attached to a lower face member 112A. In an example, the multi-sector system 200 can include a plurality of upper antenna offset mounts 152A attached to along the upper face member 112A and a plurality of lower antenna offset mounts 152B attached along the lower face member 112B. For example, an individual upper antenna offset mount 152A can correspond with an adjacent individual lower antenna offset mount 152B, e.g., such that a same vertical antenna mounting pipe 124 passes through each of the corresponding upper and lower antenna offset mounts 152A & 152B. In an example, corresponding upper and lower antenna offset mounts 152A & 152B can be adjusted by an end user according to each other, e.g., concurrently or serially such as to manipulate a final orientation of their respective vertical antenna mounting pipe 124 (and thus, an antenna attached thereto). For example, the upper antenna offset mount 152A can be arranged at a lesser offset distance than that of the lower antenna offset mount 152B (or vise versa), such that the vertical antenna mounting pipe 124 is arranged at an angle to a plane defined between the upper face member 112A and the lower face member 112B (i.e., the face plane defined between points “A”, “B”, “C”, and “D” in FIG. 3. For example, an antenna attached to each of the corresponding upper and lower antenna offset mounts 152A & 152B can be positioned at an angle (e.g., greater than about 2°, about 5°, about 10°, about 15°, about 20°, or about 30°) from a face plane defined by the upper and lower face members 112A & 112B.

FIG. 4A, FIG. 4B, and FIG. 4C depict an example of a mounting assembly attached to a monopole. The mounting assembly 400 is substantially similar to the multi-sector system 200 of FIG. 2 and FIG. 3. The components, structures, configuration, functions, etc. (e.g., movement and arrangement described with respect to the antenna offset mounts 152) of the mounting assemblies 400 can therefore be the same as or substantially similar to that described in detail above with reference to the multi-sector system 200. FIG. 4A depicts a top view of an example of the mounting assembly. An upper section 400A of a mounting assembly 400 can include or use a first upper arm 402A, a second upper arm 404A, a third upper arm 406A, a split-face upper rail 408A, an upper pole attachment mount 410A, a plurality of upper antenna offset mounts 152A, and a plurality of lower antenna offset mounts 152B. While these components labeled “upper” are intended to be used in a structurally stable mounting structure sector together with similar components labeled “lower,” this is preferred but not required. As such, a mounting assembly 400 can include parts of the upper section 400A without needing to include any corresponding parts of a lower section, or vice-versa.

In the top view in FIG. 4A, each of the first, second, and third upper arms 402A, 404A, & 406A can be attached at respective proximal ends to the upper pole attachment mount 410A. The proximal end of the second upper arm 404A can be located between (e.g., offset from) the proximal ends of the first and third upper arms 402A and 406A. The split-face upper rail 408A can be used as an exterior peripheral distal surface for mounting the antennas or other communications equipment, such as directly or via the vertical antenna mounting pipes 424 fastened thereto. The split-face upper rail 408A can include or use a first upper face member 412A and a second upper face member 414A individually joined to and jointly bisected by the second upper arm 404A at a distal end of the second upper arm 404A. Here, the distal end of the second upper arm 404A defines a hinged or other upper medial break point between the first upper face member 412A and the second upper face member 414A. This upper medial break point can allow the first upper face member 412A and the second upper face member 414A to each be non-orthogonally couplable to the second upper arm 404A-which can help increase the collective azimuthal directionality of antennas mounted via one of the individual first upper face member 412A or the second individual upper face member 414A. Stated differently, a first angle θ₁ at a joint between the second upper arm 404A and the first upper face member 412A and a second angle θ₂ at a joint between the second upper arm 404A and the second upper face member 414A can each be non-orthogonal angles. The first angle θ₁ and the second angle θ₂ can be acute angles. The first angle θ₁ and the second angle θ₂ can be angles between about 45 degrees and about 89 degrees. The first angle θ₁ and the second angle θ₂ can be angles between about 60 degrees and about 89 degrees. The first angle θ₁ and the second angle θ₂ can be angles between about 45 degrees and about 75 degrees. The first angle θ₁ and the second angle θ₂ can be angles between about 55 degrees and about 65 degrees. Also, the first upper face member 412A and the second upper face member 414A can be arranged an angle between about 410 degrees and about 430 degrees. Thus, as shown in FIG. 4A, the second upper arm 404A can extend distally outward from the monopole beyond a straight line defined between respective distal ends of the first upper arm 402A and the third upper arm 406A. Also, the upper medial break point can extend beyond a straight line defined between respective distal ends of the first upper arm 402A and the third upper arm 406A. In an example, the first, second, and third upper arms 402A, 404A, and 406A can extend from the upper pole attachment mount 410A at about the same distance. Particularly, the respective attachment points of the first upper face member 412A and the second upper face member 414A can be about equidistant from the upper pole attachment mount 410A. Here, the first, second, and third upper arms 402A, 404A, and 406A can each be about the equal in length. (the middle arm is longer in length to create the split in the faces)

In an example, the first upper arm 402A, the second upper arm 404A, and the first upper face member 412A are each connected at respective lateral ends such as to form a first triangle. Also, the third upper arm 406A, the second upper arm 404A, and the second upper face member 414A can each be connected at respective lateral ends such as to form a second triangle. The first triangle or the second triangle can be a substantially isosceles triangle or a substantially equilateral triangle. Herein, “substantially isosceles” and “substantially equilateral” refer to a general shape formed by an arrangement of the arms and face members, such as allowing for a linear or other offset between the attachment points of the proximal ends of the first, second, and third upper arms 402A, 404A, and 406A from one another.

The split-face upper rail 408A allows for mounting of antennas or communications equipment at the first upper face member 412A and the second upper face member 414A, the angular orientation of the two being at two different azimuths. Thus, equipment can be mounted, facing outward on respective exterior distal peripheral rails approximately equidistant from the monopole, at two different azimuths, a first azimuth 434A and a second azimuth 434B, using a single mounting assembly. The two different azimuths 434A and 434B can have an angular difference between one another ranging between about 50° and about 70°. This arrangement also allows antennas to be turned to create more flexibility in orienting azimuths.

The upper pole attachment mount 410A can include or use an upper proximal portion pivotably attached to an upper distal portion, and the first, second, and third upper arms 402A, 104A, and 106A can be attached to the upper distal portion of the upper pole attachment mount 110A. This can help permit some adjustment of components extending distally outward from the upper distal portion of the upper pole attachment mount 410A, which, in turn, can help increase flexibility in obtaining a desired azimuthal orientation of antennas mounted to this sector via the pivotable upper pole attachment mount 410A.

While the description of FIG. 4A has focused on certain “upper components” of the mounting assembly, as mentioned, it is preferred that these “upper components” be used together with corresponding lower components, such as shown in FIGS. 4B and IC. FIG. 4B depicts a side view of an example of a mounting assembly 400. In an example, the mounting assembly can include or use an upper section 400A and a similar corresponding lower section 400B. The upper section 400A and the lower section 400B can be respectively attached to the upper pole attachment mount 410A and a lower pole attachment mount 410B. The upper section 400A and the lower section 400B can be attached to each other such as can include bracing 426 located therebetween. In an example as depicted in FIG. 4B, the bracing 426 can be cross-bracing. The bracing can extend between respective proximal and distal ends of any of the upper and lower arms 402A, 404A, 406A, 402B, 404B, or 406B. Also, vertical antenna mounting pipes 424 can extend between the split-face lower rail 408B and the corresponding split-face upper rail 408A, such as by being bolted thereto, such as using U-bolts, or otherwise.

FIG. 4C depicts an isometric view of an example of a mounting assembly 400. The upper section 100A can include the first, second, and third upper arms 402A, 404A, & 406A, the split-face upper rail 408A, and the upper pole attachment mount 410A. The lower section 400B can be arranged similar to that previously described with respect to the upper section 400A. The lower section 400B can include first, second, and third lower arms 402B, 404B, & 406B can be attached at respective proximal ends to the lower pole attachment mount 410B. The proximal end of the second lower arm 404B can be located between (e.g., offset from) the proximal ends of the first and third lower arms 402B and 406B. The split-face lower rail 408B can be used as an exterior peripheral distal surface for mounting the antennas or other communications equipment, such as directly or via the vertical antenna mounting pipes 424 fastened thereto. The split-face lower rail 108B can include or use a first lower face member 412B and a second lower face member 414B individually joined to and jointly bisected by the second lower arm 404B at a distal end of the second lower arm 404B. Here, the distal end of the second lower arm 404B defines a hinged or other lower medial break point between the first lower face member 412B and the second lower face member 414B. This lower medial break point can allow the first lower face member 412B and the second lower face member 414B to each be non-orthogonally couplable to the second lower arm 404B—which can help increase the collective azimuthal directionality of antennas mounted via one of the individual first lower face member 412B or the individual second lower face member 414B. Stated differently, a third angle at a joint between the second lower arm 104B and the first lower face member 412B and a fourth angle at a joint between the second lower arm 404B and the second lower face member 414B can each be non-orthogonal angles. The third angle and the fourth angle can be acute angles. The third angle and the fourth angle can be angles between about 45 degrees and about 89 degrees. The third angle and the fourth angle can be angles between about 60 degrees and about 89 degrees. The third angle and the fourth angle can be angles between about 45 degrees and about 75 degrees. The third angle and the fourth angle can be angles between about 55 degrees and about 65 degrees. Also, the first lower face member 412B and the second lower face member 414B can be arranged an angle between about 410 degrees and about 430 degrees. Thus, as shown in FIG. 4C, the second lower arm 104B can extend distally outward from the monopole beyond a straight line defined between respective distal ends of the first lower arm 402B and the third lower arm 406B. Also, the lower medial break point can extend beyond a straight line defined between respective distal ends of the first lower arm 402B and the third lower arm 406B. In an example, the first, second, and third lower arms 402B, 404B, and 406B can extend from the lower pole attachment mount 410B at about the same distance. Particularly, the respective attachment points of the first lower face member 412B and the second lower face member 414B can be about equidistant from the lower pole attachment mount 410B. Here, the first, second, and third lower arms 402B, 404B, and 406B can each be about the equal in length.

In an example, the first lower arm 402B, the second lower arm 404B, and the first lower face member 412B are each connected at respective lateral ends such as to form a third triangle. Also, the third lower arm 406B, the second lower arm 404B, and the second lower face member 414B can each be connected at respective lateral ends such as to form a fourth triangle. The third triangle or the fourth triangle can be a substantially isosceles triangle or a substantially equilateral triangle. Herein, “substantially isosceles” and “substantially equilateral” refer to a general shape formed by an arrangement of the arms and face members, such as allowing for a linear or other offset between the attachment points of the proximal ends of the first, second, and third lower arms 402B, 404B, and 406B from one another.

The split-face lower rail 408B allows for mounting of antennas or communications equipment at the first lower face member 412B and the second lower face member 414B, the angular orientation of the two being at two different azimuths. Thus, equipment can be mounted, facing outward on respective exterior distal peripheral rails approximately equidistant from the monopole, at two different azimuths using a single mounting assembly. The two different azimuths can have an angular difference between one another ranging between about 50° and about 70°.

The lower pole attachment mount 410B can include or use a lower proximal portion pivotably attached to a lower distal portion, and the first, second, and third lower arms 402B, 404B, and 406B can be attached to the lower distal portion of the lower pole attachment mount 410B. This can help permit some adjustment of components extending distally outward from the lower distal portion of the lower pole attachment mount 410B, which, in turn, can help increase flexibility in obtaining a desired azimuthal orientation of antennas mounted to this sector via the pivotable lower pole attachment mount 410B.

In an example, the upper section 400A and the lower section 400B can be arranged together as an assembly. The arrangement of both the upper section 400A and lower section 400B together, such as via the bracing 426, can provide structural integrity and can allow for mounting of more/heavier equipment than certain mounts lacking two full upper and lower sections and attaching to the monopole at two locations. The increased structural integrity and support can allow for mounting of the equipment in a manner that can help the equipment withstand wind, vibration or oscillation of the monopole, or other environmental factors affecting the mounting assembly 400.

One or more mounting assemblies 400 can be attached, clamped, or coupled to a monopole such as via an upper bracket 422A or the lower bracket 422B (as depicted in FIG. 4B). The upper bracket 422A and lower bracket 422B can each include a collar, such as a tri-collar bracket assembly that can accommodate a 10-inch through 40-inch monopole extending therethrough. In an example, any number (e.g., two or three) of mounting assemblies can be mounted to the upper mounting bracket 422A or the lower mounting bracket 422B. While mounting assemblies and systems herein are generally described with respect to monopole towers, the same can be used with other types of telecommunications towers, masts, or poles. As such, suitable brackets corresponding with the different types of telecommunications structures can be used such as to provide attachment locations for each mounting assembly in a similar fashion as depicted in FIG. 4B with respect to bracket 422A and bracket 422B.

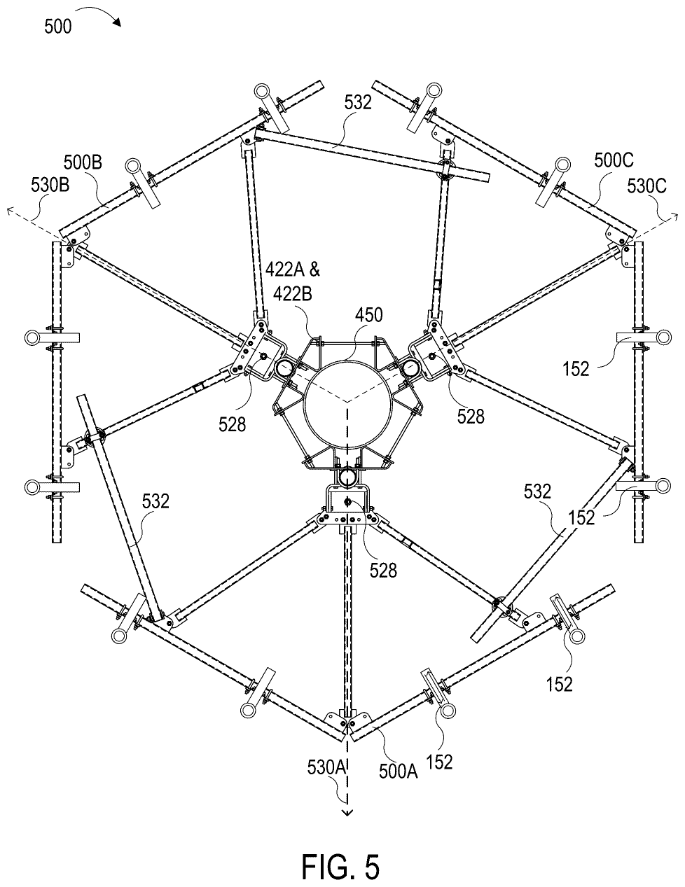

FIG. 5 depicts a mounting system 500 including multiple mounting assemblies 500A, 500B, and 500C attached adjacent to one another around a monopole. The mounting assemblies 500A, 500B, and 500C are each substantially similar to the multi-sector system 200 of FIG. 2 and FIG. 3 and also substantially similar to the mounting assembly 400 of the example of FIG. 4A, FIG. 4B, and FIG. 4C. The components, structures, configuration, functions, etc. (e.g., movement and arrangement described with respect to the antenna offset mounts 152) of mounting assemblies 500A, 500B, and 500C can therefore be the same as or substantially similar to that described in detail above with reference to the multi-sector system 200 and to the mounting assembly 400. In an example, any number of mounting assemblies can be fixed to the monopole 250, such as fixed to the upper mounting bracket 422A or the lower mounting bracket 422B. In an example, the number of mounting assemblies included in the mounting system 500 can be three or less. Each of the mounting assemblies can be constructed or assembled on the ground and can be raised independently of one another for fixing to the monopole such as at the bracket 422A or the bracket 422B. The respective upper pole attachment mount and the lower pole attachment mount of each of the mounting assemblies 500A, 500B, and 500C can be respectively coupled to the upper mounting bracket 422A and the lower mounting bracket 422B. Each of the mounting assemblies 500A, 500B, and 500C can rotate independently from one another such as by rotating about pivot points 528 of each of their respective upper and lower pole attachment mounts. Each of the mounting assemblies 500A, 500B, and 500C can rotate independently from one another such that azimuths 530A, 530B, and 530C at the medial break point of each respective mounting assembly can range from about 90° to about 180° apart from one another. Two mounting assemblies can be tied to each other such as by a tie back 532. The tie backs 532 can restrain rotation of the mounting assemblies 500A, 500B, and 500C about their respective pivot points 528. In an example, a first arm of a mounting assembly (e.g., mounting assembly 200A) can be bound to a third arm of an adjacent mounting assembly (e.g., mounting assembly 200B) via the tie back 532. In an example, the tie backs 532 can be loosened or otherwise uncoupled and an angular orientation of each of the mounting assemblies 500A, 500B, and 500C can be adjusted. Coupling the tic backs 532 can preserve an adjustment of the angular orientation of the mounting assemblies 500A, 500B, and 500C.

In an example, wherein the mounting assemblies 500A, 500B, and 500C can arranged to substantially form a convex polygon around the monopole. Herein, “substantially form a convex polygon” means that the respective split-face upper rails (or the split face lower rails) of each of the mounting assemblies 500A, 500B, and 500C formed a general shape of a convex polygon, such as allowing for an offset between respective attachment points and an offset between respective split-face rails from one another. The convex polygon can be a hexagon. In an example, the mounting assemblies 500A, 500B, and 500C can be adjusted about their respective pivot points 528 such that the vertices of the hexagon are rotatable to collectively travel around an entire circumscribed circle of the hexagon while all pole attachment mounts and mounting brackets 422A and 422B remain in a fixed position relative to the monopole 250. Stated differently, the vertices hexagon can effectively rotate to spin all possible different hexagonal orientations 360° around the monopole without needing to be unclamped therefrom at the mounting brackets 422A and 422B. The mounting assemblies 500A, 500B, and 500C can be adjusted about their respective pivot points 528 such that interior angles of the hexagon can each be modified between about 110° and about 114°.

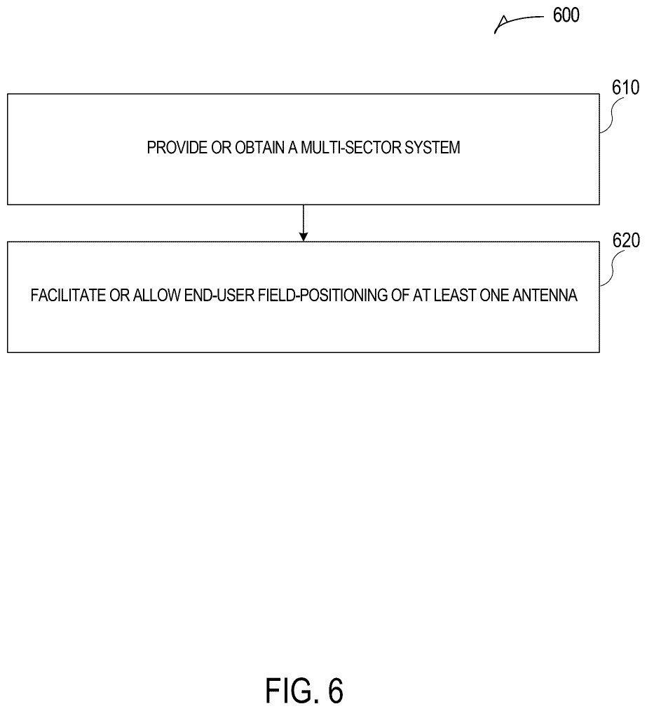

FIG. 6 illustrates a flowchart of a process for mounting communication equipment to a monopole tower. For example, the process can involve end-user assembly or adjustment of the system 200 of FIG. 2 and FIG. 3, mounting assembly 400 of FIG. 4A, or the system 500 of FIG. 5.

At 610, a multi-sector system can be provided for or obtained by an end-user such as a tower technician, a tower equipment installer, a tower climber, etc., the multi-sector system including a plurality of antenna mounting assemblies. Each individual antenna mounting assembly in this system can include an attachment mount for securing the assembly to the monopole tower. In an example, the antenna mounting assembly can include a peripheral portion having a medial break between two non-aligned face portions.

At 620, the process can involve facilitating or allowing end-user field-positioning of at least one antenna. This antenna can be attached to an individual antenna offset mount, which can be coupled with a face member of the attachment mount. For example, the antenna can be attached at or near the distal end of one or more antenna offset mounts. Such attachment can allow an end-user to position this antenna at a first specified offset distance from the face member. Also, an end-user can adjust an individual antenna offset mount, such as to allow for positioning the antenna at a second specified offset distance from the face member, e.g., such that the second specified offset distance is at least about one inch greater (e.g., at least about 3 inches, at least about 4 inches, or at least about 5 inches) than the first specified offset distance. In an example, first and second antenna offset mounts can be adjusted independently from each other. These offset mounts can be removably coupled to an upper face member of the attachment mount and a lower face member of the attachment mount, respectively. Such independent adjustment capability can facilitate modification of the offset distance of the antenna from the respective upper or lower face member, allowing for precise tuning of antenna position.

In an example, the process can include measuring a field associated with the at least one antenna. Based on this measurement, the process can allow for or facilitate end-user-positioning of the antenna, e.g., to coordinate a real-time adjustment based on actual field conditions, such as to promote desired signal coverage and performance.

For example, an antenna attached to each of the first and second antenna offset mounts can be positioned at an angle (e.g., greater than about 2°, about 5°, about 10°, about 15°, about 20°, or about 30°) from a face plane defined by the upper and lower face members. This can be achieved via adjustment of the first and second antenna offset mounts toward respective different offset distances. Such adjusting can facilitate optimal antenna orientation, which can be important for promoting signal coverage and avoiding or mitigating interference in complex network environments.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations.

What is claimed is:

1. A mounting system for mounting communication equipment to a monopole tower, the system comprising:
a first mounting assembly comprising:
an upper pole attachment mount;
a lower pole attachment mount;
first and second upper arms, respectively including proximal ends that are respectively couplable to the upper pole attachment mount;
first and second lower arms, respectively including proximal ends that are respectively couplable to the lower pole attachment mount;
an upper face member, coupled to respective distal ends of the first and second upper arms; and
a lower face member, coupled to respective distal ends of the first and second lower arms; and
a plurality of antenna offset mounts, an individual antenna offset mount including a coupler for removably coupling with the upper or lower face member, the individual antenna offset mount end-user-adjustable to position an antenna attached at or near a distal end of the antenna offset mount, at a first specified offset distance from the upper or lower face member.

2. The mounting system of claim 1, wherein the individual antenna offset mount is end-user-adjustable to position the antenna attached at or near the distal end of the antenna offset mount at a second specified offset distance from the corresponding upper or lower face member;
wherein the second specified offset distance is at least one inch greater than the first specified offset distance.

3. The mounting system of claim 1, wherein the individual antenna offset mount includes an elongate member configured to travel, in a direction substantially perpendicular to the upper or lower face member, along the antenna offset mount and thereby modify an offset distance of the antenna from the upper or lower face member.

4. The mounting system of claim 1, wherein:
the plurality of antenna offset mounts include first and second antenna offset mounts respectively, removably coupled to the upper face member and the lower face member; and
the first and second antenna offset mounts are each independently end-user-adjustable to modify an offset distance of the antenna from the respective upper or lower upper face member.

5. The mounting system of claim 4, wherein the first and second antenna offset mounts are end-user-adjustable toward respective different offset distances, such that an antenna attached to each of the first and second antenna offset mounts is capable of being positioned by an end user at an angle from a face plane defined by the upper and lower face members.

6. The mounting system of claim 4, wherein:
the plurality of antenna offset mounts include third and fourth antenna offset mounts respectively, removably coupled to the upper face member and the lower face member; and
the third and fourth antenna offset mounts are each independently end-user-adjustable from each other and from the first and second antenna offset mounts to modify an offset distance of the antenna from the respective upper or lower upper face member.

7. The mounting system of claim 6, wherein the third and fourth antenna offset mounts are each end-user-adjustable toward respective different offset distances than either of the first and second antenna offset mounts, such that a first antenna attached to the first and second antenna offset mounts is end-user-adjustable to protrude from the assembly, along its entire length, at a greater offset distance than a second antenna attached to the third and fourth antenna offset mounts.

8. A method of mounting to a monopole tower, the method comprising:
providing or obtaining a multi-sector system including a plurality of antenna mounting assemblies, an individual antenna mounting assembly including an attachment mount for securing the assembly to the monopole tower and including a peripheral portion having a medial break between two non-aligned face portions; and
allowing end-user field-positioning of at least one antenna, attached to an individual antenna offset mount coupled with a face member of the attachment mount at or near a distal end of the antenna offset mount, at a first specified offset distance from the face member.

9. The method of claim 8, comprising:
measuring a field associated with the at least one antenna; and
allowing end-user-positioning of the antenna based on the measured field.

10. The method of claim 8, wherein an individual antenna mounting assembly includes:
a first face member, non-orthogonally coupled to respective distal ends of first and second arms of the assembly; and
a second face member, non-orthogonally coupled to respective distal ends of second and third arms of the assembly;
wherein the first and second face members establish a hinged medial break point at respective interfaces with the distal end of the second arm.

11. The method of claim 8, comprising allowing end-user-adjusting the individual antenna offset mount to position the antenna, attached at or near the distal end of the antenna offset mount, at a second specified offset distance from the face member;
wherein the second specified offset distance is at least one inch greater than the first specified offset distance.

12. The method of claim 8, comprising adjusting first and second antenna offset mounts, respectively, removably coupled to an upper face member of the attachment mount and a lower face member of the attachment mount, independently from each other to modify an offset distance of the antenna from the respective upper or lower upper face member.

13. The method of claim 12, comprising positioning an antenna attached to each of the first and second antenna offset mounts at an angle from a face plane defined by the upper and lower face members, including adjusting the first and second antenna offset mounts toward respective different offset distances.

14. A mounting system for mounting communication equipment to a monopole tower, the system comprising:
a first mounting assembly comprising:
an upper pole attachment mount;
a lower pole attachment mount;
first, second, and third upper arms, respectively including proximal ends that are respectively couplable to the upper pole attachment mount, the proximal end of the second upper arm located between the proximal ends of the first and third upper arms;
first, second, and third lower arms, respectively including proximal ends that are respectively couplable to the lower pole attachment mount, the proximal end of the second lower arm located between the proximal ends of the first and third lower arms;
a first upper face member, non-orthogonally coupled to respective distal ends of the first and second upper arms;
a second upper face member, non-orthogonally coupled to respective distal ends of the second and third upper arms;
a first lower face member, non-orthogonally coupled to respective distal ends of the first and second lower arms; and
a second lower face member, non-orthogonally coupled to respective distal ends of the second and third lower arms;
wherein the first and second upper face members establish a hinged upper medial break point at respective interfaces with the distal end of the second upper arm; and
wherein the first and second lower face members establish a hinged upper medial break point at respective interfaces with the distal end of the second lower arm; and
a plurality of antenna offset mounts, an individual antenna offset mount including a coupler for removably coupling with one of the first or second upper or first or second lower face members, the individual antenna offset mount end-user-adjustable to position an antenna attached substantially at a distal end of the antenna offset mounts, at a first specified offset distance from the one of the first or second upper or first or second lower face members.

15. The mounting system of claim 14, wherein:
the distal end of the second upper arm bisects the first upper face member and the second upper face member at the hinged upper medial break point;
the hinged upper medial break point extends distally beyond a first straight line defined between the respective distal ends of the first upper arm and the third upper arm;
the distal end of the second lower arm bisects the first lower face member and the second lower face member at the hinged lower medial break point; and
the hinged lower medial break point extends distally beyond a second straight line defined between the respective distal ends of the first lower arm and the third lower arm.

16. The mounting system of claim 14, wherein the individual antenna offset mount is end-user-adjustable to position the antenna attached at or near the distal end of the antenna offset mount at a second specified offset distance from the one of the first or second upper or first or second lower face members;
wherein the second specified offset distance is at least one inch greater than the first specified offset distance.

17. The mounting system of claim 14, wherein the individual antenna offset mount includes an elongate member configured to travel, in a direction substantially perpendicular to the one of the first or second upper or first or second lower face members, through a passage of the antenna offset mount and thereby modify an offset distance of the antenna from the one of the first or second upper or first or second lower face members.

18. The mounting system of claim 14, wherein:
the plurality of antenna offset mounts include first and second antenna offset mounts respectively, removably coupled to one of the first or second upper face members and a corresponding one of the first and second lower face members; and
the first and second antenna offset mounts are each independently end-user-adjustable to modify an offset distance of the antenna from the first or second upper face member or corresponding first or second lower face member.

19. The mounting system of claim 18, wherein the first and second antenna offset mounts are end-user-adjustable toward respective different offset distances, such that an antenna attached to each of the first and second antenna offset mounts is positioned at an angle from a face plane defined by the first or second upper face member and corresponding first or second lower face member.

20. The mounting system of claim 18, wherein:
the plurality of antenna offset mounts include third and fourth antenna offset mounts respectively, removably coupled to the first or second upper face member and corresponding first or second lower face member; and
the third and fourth antenna offset mounts are each independently end-user-adjustable from each other and from the first and second antenna offset mounts to modify an offset distance of the antenna from the respective first or second upper face member or corresponding first or second lower face member.

21. The mounting system of claim 20, wherein the third and fourth antenna offset mounts are each end-user-adjustable toward respective different offset distances than either of the first and second antenna offset mounts, such that a first antenna attached to the first and second antenna offset mounts is end-user-adjustable to protrude from the assembly, along its entire length, at a greater offset distance than a second antenna attached to the third and fourth antenna offset mounts.
